(19) United States
(12) Patent Application Publication
(10) Pub. No.: US 2014/0272516 A1
(43) Pub. Date: Sep. 18, 2014

(54) Battery Pack With Heat Sink

(71) Applicant: BLACK & DECKER INC., Newark, DE (US)

(72) Inventors: Merritt Tennison, Baltimore, MD (US); Daniel White, Baltimore, MD (US); Ralphy Louis, York, PA (US)

(73) Assignee: BLACK & DECKER INC., Newark, DE (US)

(21) Appl. No.: 13/833,307

(22) Filed: Mar. 15, 2013

(51) Int. Cl. H01M 10/655

(52) U.S. Cl. CPC H01M 10/5044
USPC 429/120

(57) ABSTRACT

A battery pack including a heat sink for improved heat dissipation.

### CROSS-REFERENCE TO RELATED APPLICATIONS

This application incorporates by reference the disclosure of U.S. patent application Ser. No. 13/080,887 filed on Apr. 6, 2011.

### FIELD

The present disclosure relates to a battery pack, for use with a power tool, among other electronic devices.

### BACKGROUND

Cordless products or devices which use rechargeable batteries are prevalent in the marketplace. Rechargeable batteries may be used in numerous electronic devices ranging from computers to power tools. Since the devices use a plurality of battery cells, the battery cells are commonly packaged in a battery pack. The battery pack may in turn be used to power the devices when coupled thereto. Once depleted, the battery pack may be recharged by a battery charger. Lithium Ion chemistry battery cells currently provide the highest energy for a given volume of the available production cells. However, it is common for Lithium Ion chemistry battery cells to heat up during continued use and if allowed to reach a threshold could ignite. As such, battery packs using Lithium Ion chemistry battery cells must closely monitor the temperature of the individual cells and/or the pack.

As power requirements for devices and battery run-time increases so does the need for higher capacity batteries. In addition, some devices require ever increasing current draws, either continuous or at peak levels. As such, the currently available batteries are running hotter than in the past and are achieving these higher temperatures faster than in the past. Many electronic devices monitor the cell and/or pack temperature to insure that the pack and/or device do not overheat causing a dangerous situation. Many of these devices include thermal shutdown sensors which will turn of the device if the device and/or the pack reach a temperature threshold. In addition, many devices experience functional degradation as their temperatures rise. As such, it is imperative that the battery packs compensate for the higher temperatures and compensate more quickly than in the past.

The statements in this section merely provide background information related to the present disclosure and may not constitute prior art.

### SUMMARY

This section provides a general summary of the disclosure, and is not a comprehensive disclosure of its full scope or all of its features.

In one aspect of the disclosure, a battery pack comprises a housing defining a cavity for receiving at least one battery cell, the housing having a first side providing a connection to a tool and a second side opposed to the first side, the second side having an opening to the cavity, and a heat sink positioned in the opening such that an interior surface of the heat sink is exposed to the cavity and an exterior surface of the heat sink is exposed to ambient air outside the housing.

In another aspect of the disclosure, a battery pack comprising a housing defining a cavity for receiving at least one battery cell, the housing having a first side providing a connection to a tool and a second side, opposed to the first side, the second side having a mesh configuration providing a plurality of openings between the cavity and ambient air outside the housing, and a heat sink in the cavity positioned adjacent to the mesh configuration.

In yet another aspect of the disclosure, a battery pack comprising a housing defining a cavity for receiving at least one battery cell, the housing having a first side having a mesh configuration providing a plurality of openings between the cavity and ambient air outside the housing, and a heat sink in the cavity positioned adjacent to the mesh configuration.

Further areas of applicability will become apparent from the description provided herein. It should be understood that the description and specific examples are intended for purposes of illustration only and are not intended to limit the scope of the present disclosure.

### DRAWINGS

FIG. 1 is a perspective view of a first exemplary embodiment of a battery pack;

FIG. 2 is another perspective view of the battery pack of FIG. 1;

FIG. 3 is another perspective view of the battery pack of FIG. 1;

FIG. 4 is another perspective view of the battery pack of FIG. 1;

FIG. 5 is an exploded perspective view of various exemplary elements of the battery pack of FIG. 1;

FIG. 6 is a section perspective view of various exemplary elements of the battery pack of FIG. 1;

FIG. 7 is another section perspective view of various exemplary elements of the battery pack of FIG. 1;

FIG. 8 is another section perspective view of various exemplary elements of the battery pack of FIG. 1;

FIG. 9 is a top plan view of an exemplary heat sink of the battery pack of FIG. 1;

FIG. 10 is a side view of the exemplary heat sink of FIG. 9;

FIG. 11 is a section view of the exemplary heat sink of FIG. 9 along line 11-11;

FIG. 12 is a top plan view of an exemplary bottom housing portion of the battery pack of FIG. 1;

FIG. 13 is a bottom plan view of the exemplary bottom housing portion of the battery pack of FIG. 1;

FIG. 14 is partial perspective view of various exemplary elements of a second exemplary embodiment of the battery pack of FIG. 1;

FIG. 15 is a perspective view of a second exemplary embodiment of a battery pack;

FIG. 16 is another perspective view of the battery pack of FIG. 15;

FIG. 17 is another perspective view of the battery pack of FIG. 15;

FIG. 18 is another perspective view of the battery pack of FIG. 15;

FIG. 19 is an exploded perspective view of various exemplary elements of the battery pack of FIG. 15;

FIG. 20 is a section perspective view of various exemplary elements of the battery pack of FIG. 15;

FIG. 21 is another section perspective view of various exemplary elements of the battery pack of FIG. 15;

FIG. 22 is another section perspective view of various exemplary elements of the battery pack of FIG. 15;

FIG. 23 is a top plan view of an exemplary heat sink of the battery pack of FIG. 15;

FIG. 24 is a side view of the exemplary heat sink of FIG. 23;

FIG. 25 is a section view of the exemplary heat sink of FIG. 23 along line 25-25;

FIG. 26 is a section view of the exemplary heat sink of FIG. 23 along line 26-26;

FIG. 27 is a section view of the exemplary heat sink of FIG. 23 along line 27-27;

FIG. 28 is a top plan view of an exemplary bottom housing portion and heat sink of the battery pack of FIG. 15;

FIG. 29 is a bottom plan view of the exemplary bottom housing and heat sink of the battery pack of FIG. 15;

FIG. 30 is a perspective view of a third exemplary embodiment of a battery pack;

FIG. 31 is another perspective view of the battery pack of FIG. 30;

FIG. 32 is an exploded perspective view of various exemplary elements of the battery pack of FIG. 30;

FIG. 33 is a section perspective view of various exemplary elements of the battery pack of FIG. 30;

FIG. 34 is another section perspective view of various exemplary elements of the battery pack of FIG. 30;

FIG. 35 is another section perspective view of various exemplary elements of the battery pack of FIG. 30;

FIG. 36 is a top plan view of an exemplary heat sink of the battery pack of FIG. 30;

FIG. 37 is a side view of the exemplary heat sink of FIG. 36;

FIG. 38 is a section view of the exemplary heat sink of FIG. 36 along line 38-38;

FIG. 39 is a section view of the exemplary heat sink of FIG. 36 along line 39-39;

FIG. 40 is a section view of the exemplary heat sink of FIG. 36 along line 40-40;

FIG. 41 is a top plan view of an exemplary bottom housing portion and heat sink of the battery pack of FIG. 30;

FIG. 42 is a bottom plan view of the exemplary bottom housing and heat sink of the battery pack of FIG. 30;

FIG. 43 is a perspective view of a fourth exemplary embodiment of a battery pack;

FIG. 44 is another perspective view of the battery pack of FIG. 43;

FIG. 45 is an exploded perspective view of various exemplary elements of the battery pack of FIG. 43;

FIG. 46 is a section perspective view of various exemplary elements of the battery pack of FIG. 43;

FIG. 47 is another section perspective view of various exemplary elements of the battery pack of FIG. 43;

FIG. 48 is another section perspective view of various exemplary elements of the battery pack of FIG. 43;

FIG. 49 is a top plan view of an exemplary heat sink of the battery pack of FIG. 43;

FIG. 50 is a side view of the exemplary heat sink of FIG. 49;

FIG. 51 is a section view of the exemplary heat sink of FIG. 49 along line 51-51;

FIG. 52 is a section view of the exemplary heat sink of FIG. 49 along line 52-52;

FIG. 53 is a section view of the exemplary heat sink of FIG. 49 along line 53-53;

FIG. 54 is a top plan view of an exemplary bottom housing portion and heat sink of the battery pack of FIG. 43;

FIG. 55 is a bottom plan view of the exemplary bottom housing and heat sink of the battery pack of FIG. 43

FIG. 56 is a perspective view of a fifth exemplary embodiment of a battery pack;

FIG. 57 is another perspective view of the battery pack of FIG. 56;

FIG. 58 is an exploded perspective view of various exemplary elements of the battery pack of FIG. 56;

FIG. 59 is a section perspective view of various exemplary elements of the battery pack of FIG. 56;

FIG. 60 is another section perspective view of various exemplary elements of the battery pack of FIG. 56;

FIG. 61 is another section perspective view of various exemplary elements of the battery pack of FIG. 56;

FIG. 62 is a top plan view of an exemplary heat sink of the battery pack of FIG. 56;

FIG. 63 is a side view of the exemplary heat sink of FIG. 62;

FIG. 64 is a section view of the exemplary heat sink of FIG. 62 along line 64-64;

FIG. 65 is a top plan view of an exemplary bottom housing portion and heat sink of the battery pack of FIG. 56;

FIG. 66 is a bottom plan view of the exemplary bottom housing and heat sink of the battery pack of FIG. 56;

FIG. 67 is a perspective view of a sixth exemplary embodiment of a battery pack;

FIG. 68 is another perspective view of the battery pack of FIG. 67;

FIG. 69 is an exploded perspective view of various exemplary elements of the battery pack of FIG. 67;

FIG. 70 is a section perspective view of various exemplary elements of the battery pack of FIG. 67;

FIG. 71 is another section perspective view of various exemplary elements of the battery pack of FIG. 67;

FIG. 72 is another section perspective view of various exemplary elements of the battery pack of FIG. 67;

FIG. 73 is a top plan view of an exemplary heat sink of the battery pack of FIG. 67;

FIG. 74 is a side view of the exemplary heat sink of FIG. 73;

FIG. 75 is a section view of the exemplary heat sink of FIG. 73 along line 75-75;

FIG. 76 is a top plan view of an exemplary bottom housing portion and heat sink of the battery pack of FIG. 67;

FIG. 77 is a bottom plan view of the exemplary bottom housing and heat sink of the battery pack of FIG. 67;

FIG. 78 is a section perspective view of a seventh exemplary embodiment of a battery pack;

FIG. 79 is a section perspective view of an eighth exemplary embodiment of a battery pack;

FIG. 80 is a section perspective view of an exemplary alternate embodiment of a heat sink in accordance with the present disclosure;

FIG. 81 is a section perspective view of an exemplary alternate embodiment of a heat sink in accordance with the present disclosure.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

The present disclosure relates to a rechargeable battery pack, often referred to as “a secondary battery” that can be used with a variety of electronic devices, for example, power tools, automobiles, cell phones, and portable computers. This disclosure will focus on use of the battery pack with a power tool however, the invention is not limited to such an application. The range of power tools that may be used with the battery pack include, but is not limited to, drills, drill/drivers, hammer drill/drivers, rotary hammers, screwdrivers, impact drivers, circular saws, jig saws, reciprocating saws, band saws, cut-off tools, cut-out tools, shears, sanders, vacuums, routers, adhesive dispensers, concrete vibrators, staplers, rotary lasers and nailers. An exemplary power tool is illustrated in U.S. Pat. No. 8,317,350. The battery pack may also be used with non-motorized devices such as lights, line lasers, laser pointers, inspection devices, etc.

Applicants will establish a convention solely for purposes of this disclosure and for explaining the various embodiments, based on the illustrations but the scope of the embodiments should not be limited to this convention. In other words, for example, what is denoted as “top” could be denoted as “bottom,” or what is denoted as “first” could be denoted as “second” in a different disclosure. Furthermore, what is illustrated in one orientation in one figure could be illustrated in a different orientation in another figure. This should not affect the convention or limit the scope of the disclosure.

FIGS. 1-13 illustrate a first exemplary embodiment of the present invention. This embodiment includes a battery pack 10. The battery pack 10 has a housing 12. The housing 12 may be constructed of plastic or other suitable material for the application. The housing 12 includes a top housing portion 14 and a bottom housing portion 16. The top and bottom housing portions 14, 16 are joined at a horizontal parting line 18. The housing 12 also includes a first side 20, a second side 22, a front 24 and a back 26. The housing 12 is shown with a top and bottom portion. Other alternate configurations may be used to provide the housing for the various other components to be discussed below. For example, the housing could consist of two side housings that are joined at a vertical parting line.

The battery pack 10 includes a connection mechanism 28 for mechanically and electrically coupling the battery pack 10 to a power tool. As noted above, the inventive features of the present invention may be use in battery packs for other electronic devices which will require device specific connection mechanisms. The connection mechanism 28 includes rails 30 and grooves 32 for a sliding connection with the tool. The tool will include corresponding rails and grooves. The connection mechanism 28 also includes a spring loaded latch 34. The latch 34 will include a portion for receiving a user's finger to depress the latch 34 and a catch feature that will be received in the base of the tool to maintain the battery pack 10 fixed to the tool. The battery pack also includes a terminal block 52 including a plurality of terminals 54 for transmitting current between the battery pack 10 and the tool. The current may be both for providing power to the tool and data between the battery pack and the tool.

The battery pack 10 may also include a state of charge indicator 36 on the back 26. The state of charge indicator 36 may include an activation button 38 and a plurality of lights 40.

The bottom housing portion 16 includes a bottom surface 42. The bottom surface 42 is configured to include a mesh portion 44. In the illustrated embodiment, the mesh portion 44 extends across most of the bottom surface 42. However, other configurations for the mesh portion 44 are contemplated by this disclosure. The mesh portion 44 includes a grid of holes 46 through the bottom surface 42 of the bottom housing portion 16. The holes 46 extend from outside the housing 12 to a cavity 48 created by the top housing portion 14 and the bottom housing portion 16.

The battery pack 10 includes a plurality of battery cells 50. This particular example illustrates five cells however, more or less cells may be present and the scope of the invention should not be limited to five cells. The cells 50 are typically Li Ion chemistry cells but may be other chemistries.

The bottom housing portion 16 includes an interior bottom surface 56 and first and second bottom housing interior side surfaces 58, 60. The interior bottom surface 56 includes the mesh portion 44 and the holes 46. The interior bottom surface 56 may also include a plurality of cross bars 62. These cross bars 62 may provide the bottom housing portion 16 with structural rigidity.

The battery pack 10 also includes a heat sink 64. The heat sink 64 may, for example, be made of aluminum, zinc or magnesium. The heat sink 64 is preferably constructed of a material that has high specific heat and high heat transfer characteristics. The heat sink 64 has an exterior surface 66 and an interior surface 68. The exterior surface 66 of the heat sink 64 is placed on the bottom housing interior surface 56. The exterior surface 66 of the heat sink 64 may include a lower plurality of recesses 70 which would receive the plurality of cross bars 62 to assist in placing the heat sink 64 on the bottom housing interior surface 56. The heat sink 64 may simply sit on the bottom housing interior surface 56 or may be configured to establish a friction fit between the bottom housing interior side surfaces 58, 60.

The interior surface 68 includes a plurality of concave receiving bays 72. Each bay 72 receives one of the plurality of cells 50. The cells rest on and are in direct contact with the heat sink 64. The interior surface 68 may also includes an upper plurality of recesses 74 which could receive corresponding cross bars 76 of a battery harness 78. The battery harness 78 and the cross bars 76 assist to seat the cells 50 in the heat sink 64.

As current flows from the battery cells 50 to power the tool, heat is generated. Through both convection and conduction heat is transferred from the cells 50 to the heat sink 64. As the temperature of the heat sink 64 increases the heat sink 64 is cooled by the ambient air outside the battery pack 10 via the holes 46 in the mesh portion 44 of the bottom housing portion 16. The size and shape of the holes 46 is selected in order to provide the greatest heat transfer from the heat sink 64 to the ambient air while also providing unwanted access to the heat sink 64 by a user.

When the heat sink 64 is seated in the bottom housing portion 16 adjacent to and abutting the mesh portion 44 and the cells 50 are seated on the heat sink 64 and the top housing portion 14 and the bottom housing portion 16 are fastened to each other, the battery cells 50 are fixed in the cell bays 72 and thermally coupled to the heat sink 64. As a result, the cavity 48 is sealed from the ambient air outside the battery pack 10 and airflow is prevented from moving from the cavity 48 around the heat sink 64, and therefore, most if not all heat transfer from the cells 50 will occur through the heat sink 64 to the ambient air outside the housing 12.

In an alternate exemplary embodiment, illustrated in FIG. 14, the battery pack 10 may include a mesh portion 80 as part of one or both sides 20, 22 of the housing 12. These side mesh portions 80 may either be in addition to or as alternatives to the mesh portion 44 in the bottom housing portion 16. In an embodiment including the side mesh portions 80 the battery pack 10 will include a corresponding heat sink 82. In an embodiment without a mesh portion 44 in the bottom housing portion 16, the side heat sink 82 will simply correspond to the side mesh portion 80. In an embodiment with a mesh portion 44 in the bottom housing portion 16, the side heat sink 82 may be discrete or part of the heat sink 64.

The battery pack 10 also includes a plurality of fasteners 84 that pass through the bottom housing portion 16 and the top housing portion 14 and fasten the two housing portions to each other.

FIGS. 15-29 illustrate an alternate exemplary embodiment of the present invention. This embodiment includes a battery pack 110. The battery pack 110 has a housing 112. The housing 112 may be constructed of plastic or other suitable material for the application. The housing 112 includes a top housing portion 114 and a bottom housing portion 116. The top and bottom housing portions 114, 116 are joined at a horizontal parting line 118. The housing 112 also includes a first side 120, a second side 122, a front 124 and a back 126. The housing 112 is shown with a top and bottom portion. Other alternate configurations may be used to provide the housing for the various other components to be discussed below. For example, the housing could consist of two side housings that are joined at a vertical parting line.

The battery pack 110 includes a connection mechanism 128 for mechanically and electrically coupling the battery pack 110 to a power tool. As noted above, the inventive features of the present invention may be use in battery packs for other electronic devices which will require device specific connection mechanisms. In the illustrated example, the connection mechanism 128 includes rails 130 and grooves 132 for a sliding connection with the tool. The tool will include corresponding rails and grooves. The connection mechanism 128 also includes a spring loaded latch 134. The latch 134 will include a portion for receiving a user's finger to depress the latch 134 and a catch feature that will be received in the base of the tool to maintain the battery pack 110 fixed to the tool. The battery pack also includes a terminal block 152 including a plurality of terminals 154 for transmitting current between the battery pack 110 and the tool. The current may be both for providing power to the tool and data between the battery pack and the tool.

The battery pack 110 may also include a state of charge indicator 136 on the back 126. The state of charge indicator 136 may include an activation button 138 and a plurality of lights 140.

The bottom housing portion 116 includes an exterior surface 142. The battery pack 110 also includes a heat sink 164 that is attached to the bottom housing portion 116. The heat sink 164 is attached to the bottom housing portion 116 from the outside of the housing 112. The heat sink 164 includes wings 165 that abut against a portion of the exterior surface 142 of the bottom housing portion 116. The heat sink 164 has an exterior surface 166 and an interior surface 168. The heat sink 164 is configured such that when the heat sink 164 is attached to the bottom housing portion 116, the exterior surface 166 of the heat sink 164 is in a plane with a portion of the bottom surface 142. Such a configuration allows the battery pack 110 to easily rest on a surface when the battery pack 110, either alone or in conjunction with a tool, is placed bottom surface 142 down.

The battery pack 110 includes a plurality of fasteners 184 that pass through the heat sink 164, the bottom housing portion 116 and the top housing portion 114 and fasten the heat sink 164 and the two housing portions to each other. Once the top housing portion 114 and the bottom housing portion 116 are fastened, the battery cells 150 are received in the cell bays 172 and thermally coupled to the heat sink 164.

The battery pack 110 includes a plurality of battery cells 150. This particular example illustrates five cells however, more or less cells may be present and the scope of the invention should not be limited to five cells. The cells 150 are typically Li Ion chemistry cells but may be other chemistries.

The terminal block 152 including the plurality of terminals 154 is illustrated. The bottom housing portion 116 includes an opening 146 that receives the heat sink 164. When the heat sink 164 is placed in the opening 146 and the heat sink 164 and the top and bottom housing portions 114, 116 are fastened to each other, a seal is formed between the ambient air outside the battery pack 110 and a cavity 148 inside the housing 112. The bottom housing portion 116 includes a bottom housing interior surface 156 and first and second bottom housing interior side surfaces 158, 160.

The heat sink 164 may, for example, be made of aluminum, zinc or magnesium. The heat sink 164 is preferably constructed of a material that has high specific heat and high heat transfer characteristics.

The interior surface 168 includes a plurality of concave receiving bays 172. Each bay 172 receives one of the plurality of cells 150. In the illustrated embodiment, the cells 150 rest on and are in direct contact with the heat sink 164. The interior surface 168 may also includes an upper plurality of recesses 174 which could receive corresponding cross bars 176 of a battery harness 178. The battery harness 178 and the cross bars 176 assist to seat the cells 150 in the heat sink 164.

As current flows from the battery cells 150 to power the tool, heat is generated. Through both convection and conduction heat is transferred from the cells 150 to the heat sink 164. As the temperature of the heat sink 164 increases the heat sink 164 is cooled by the ambient air outside the battery pack 110. The size and shape of the heat sink 164 is selected in order to provide the greatest heat transfer from the heat sink 164 to the ambient air while also minimizing unwanted injury by a user.

When the heat sink 164 is seated in the bottom housing portion 116 and the cells 150 are seated on the heat sink 164 and the heat sink 164 and the top housing portion 114 and the bottom housing portion 116 are fastened to each other, the battery cells 150 are fixed in the cell bays 172 and thermally coupled to the heat sink 164. As a result, the cavity 148 is sealed from the ambient air outside the battery pack 110 and airflow is prevented from moving from the cavity 148 around the heat sink 164, and therefore, most if not all heat transfer from the cells 150 will occur through the heat sink 164 to the ambient air outside the housing 112.

FIGS. 30-42 illustrate an alternate exemplary embodiment of the present invention. This embodiment includes a battery pack 210. The battery pack 210 has a housing 212. The housing 212 may be constructed of plastic or other suitable material for the application. The housing 212 includes a top housing portion 214 and a bottom housing portion 216. The top and bottom housing portions 214, 216 are joined at a horizontal parting line 218. The housing 212 also includes a first side 220, a second side 222, a front 224 and a back 226. The housing 212 is shown with a top and bottom portion. Other alternate configurations may be used to provide the housing for the various other components to be discussed below. For example, the housing could consist of two side housings that are joined at a vertical parting line.

The battery pack 210 includes a connection mechanism 228 for mechanically and electrically coupling the battery pack 210 to a power tool. As noted above, the inventive features of the present invention may be use in battery packs for other electronic devices which will require device specific connection mechanisms. In the illustrated example, the connection mechanism 228 includes rails 230 and grooves 232 for a sliding connection with the tool. The tool will include corresponding rails and grooves. The connection mechanism 228 also includes a spring loaded latch 234. The latch 234 will include a portion for receiving a user's finger to depress the latch 234 and a catch feature 235 that will be received in the base of the tool to maintain the battery pack 210 fixed to the tool. The battery pack also includes a terminal block 252 including a plurality of terminals 254 for transmitting current between the battery pack 210 and the tool. The current may be both for providing power to the tool and data between the battery pack and the tool.

The battery pack 210 may also include a state of charge indicator 236 on the back 226. The state of charge indicator 236 may include an activation button 238 and a plurality of lights 240.

The bottom housing portion 216 includes an exterior surface 242. The battery pack 210 also includes a heat sink 264 that is attached to the bottom housing portion 216. The heat sink 264 is attached to the bottom housing portion 216 from the outside of the housing 212. The bottom housing portion 216 includes an interior surface 256 and an opening 246. The heat sink 264 is positioned in the opening 246. The opening 246 and the heat sink 264 are configured such that a friction fit is formed between the opening 246 and the heat sink 264. The heat sink 264 has an exterior surface 266 and an interior surface 268. The heat sink 264 includes wings 265 that abut against a portion of the exterior surface 242 of the bottom housing portion 316. The heat sink 264 is configured such that when the heat sink 264 is attached to the bottom housing portion 216 and the bottom housing portion 216 is fastened to the top housing portion 214, the exterior surface 266 of the heat sink 264 is in a plane with a portion of the bottom surface 242. Such a configuration allows the battery pack 210 to easily rest on a surface when the battery pack 210, either alone or in conjunction with a tool, is placed bottom surface 242 down.

The battery pack 210 includes a plurality of fasteners 284 that pass through the bottom housing portion 216 and the top housing portion 214 and fasten the two housing portions to each other. Once the top housing portion 214 and the bottom housing portion 216 are fastened, the battery cells 250 are received in the cell bays 272 and thermally coupled to the heat sink 264.

The battery pack 210 includes a plurality of battery cells 250. This particular example illustrates five cells however, more or less cells may be present and the scope of the invention should not be limited to five cells. The cells 250 are typically Li Ion chemistry cells but may be other chemistries.

The terminal block 252 including the plurality of terminals 254 is illustrated. The bottom housing portion 216 includes an opening 246 that receives the heat sink 264. When the heat sink 264 is placed in the opening 246 and the top and bottom housing portions 214, 216 are fastened to each other, a seal is formed between the ambient air outside the battery pack 210 and a cavity 248 inside the housing 212. The bottom housing portion 216 includes a bottom housing interior surface 256 and first and second bottom housing interior side surfaces 258, 260.

The heat sink 264 may, for example, be made of aluminum, zinc or magnesium. The heat sink 264 is preferably constructed of a material that has high specific heat and high heat transfer characteristics.

The interior surface 268 includes a plurality of concave receiving bays 272. Each bay 272 receives one of the plurality of cells 250. In the illustrated embodiment, the cells 250 rest on and are in direct contact with the heat sink 264. The interior surface 268 may also includes an upper plurality of recesses 274 which could receive corresponding cross bars 276 of a battery harness 278. The battery harness 278 and the cross bars 276 assist to seat the cells 250 in the heat sink 264.

As current flows from the battery cells 250 to power the tool, heat is generated. Through both convection and conduction heat is transferred from the cells 250 to the heat sink 264. As the temperature of the heat sink 264 increases the heat sink 264 is cooled by the ambient air outside the battery pack 210. The size and shape of the heat sink 264 is selected in order to provide the greatest heat transfer from the heat sink 264 to the ambient air while also minimizing unwanted injury by a user.

When the heat sink 264 is seated in the bottom housing portion 216 and the cells 250 are seated on the heat sink 264 and the heat sink 264 and the top housing portion 214 and the bottom housing portion 216 are fastened to each other, the battery cells 250 are fixed in the cell bays 272 and thermally coupled to the heat sink 264. As a result, the cavity 248 is sealed from the ambient air outside the battery pack 210 and airflow is prevented from moving from the cavity 248 around the heat sink 264, and therefore, most if not all heat transfer from the cells 250 will occur through the heat sink 264 to the ambient air outside the housing 212.

FIGS. 43-55 illustrate an alternate exemplary embodiment of the present invention. This embodiment includes a battery pack 310. The battery pack 310 has a housing 312. The housing 312 may be constructed of plastic or other suitable material for the application. The housing 312 includes a top housing portion 314 and a bottom housing portion 316. The top and bottom housing portions 314, 316 are joined at a horizontal parting line 318. The housing 312 also includes a first side 320, a second side 322, a front 324 and a back 326. The housing 312 is shown with a top and bottom portion. Other alternate configurations may be used to provide the housing for the various other components to be discussed below. For example, the housing could consist of two side housings that are joined at a vertical parting line.

The battery pack 310 includes a connection mechanism 328 for mechanically and electrically coupling the battery pack 310 to a power tool. As noted above, the inventive features of the present invention may be use in battery packs for other electronic devices which will require device specific connection mechanisms. The connection mechanism 328 includes rails 330 and grooves 332 for a sliding connection with the tool. The tool will include corresponding rails and grooves. The connection mechanism 328 also includes a spring loaded latch 334. The latch 334 will include a portion for receiving a user's finger to depress the latch 334 and a catch feature 335 that will be received in the base of the tool to maintain the battery pack 310 fixed to the tool. The battery pack also includes a terminal block 352 including a plurality of terminals 354 for transmitting current between the battery pack 310 and the tool. The current may be both for providing power to the tool and data between the battery pack and the tool.

While not illustrated in this exemplary embodiment, such an embodiment may include a state of charge indicator as described above.

The bottom housing portion 316 includes an exterior surface 342. The battery pack 310 also includes a heat sink 364 that is attached to the bottom housing portion 316. The heat sink 364 is attached to the bottom housing portion 316 from the inside of the housing 312. The bottom housing portion 316 includes an interior surface 356 and an opening 346. The heat sink 364 is positioned in the opening 346. The opening 346 and the heat sink 364 are configured such that a friction fit is formed between the opening 346 and the heat sink 364. The heat sink 364 includes wings 365 that abut against a portion of the interior surface 356 of the bottom housing portion 316. The heat sink 364 has an exterior surface 366 and an interior surface 368. The heat sink 364 is configured such that when the heat sink 364 is fixed in the opening 346 and the bottom housing portion 316 is fastened to the top housing portion 314, the exterior surface 366 of the heat sink 364 is in a plane with a portion of the bottom surface 342. Such a configuration allows the battery pack 310 to easily rest on a surface when the battery pack 310, either alone or in conjunction with a tool, is placed bottom surface 342 down.

The battery pack 310 includes a plurality of fasteners 384 that pass through the bottom housing portion 316 and the top housing portion 314 and fasten the two housing portions to each other. Once the top housing portion 314 and the bottom housing portion 316 are fastened, the battery cells 350 are received in the cell bays 372 and thermally coupled to the heat sink 364.

The battery pack 310 includes a plurality of battery cells 350. This particular example illustrates five cells however, more or less cells may be present and the scope of the invention should not be limited to five cells. The cells 350 are typically Li Ion chemistry cells but may be other chemistries.

When the heat sink 364 is placed in the opening 346 and the top and bottom housing portions 314, 316 are fastened to each other, a seal is formed between the ambient air outside the battery pack 310 and a cavity 348 inside the housing 312. The bottom housing portion 316 includes first and second bottom housing interior side surfaces 358, 360.

The heat sink 364 may, for example, be made of aluminum, zinc or magnesium. The heat sink 364 is preferably constructed of a material that has high specific heat and high heat transfer characteristics.

The interior surface 368 includes a plurality of concave receiving bays 372. Each bay 372 receives one of the plurality of cells 350. The cells 350 rest on and are in direct contact with the heat sink 364. The interior surface 368 may also includes an upper plurality of recesses 374 which could receive corresponding cross bars 376 of a battery harness 378. The battery harness 378 and the cross bars 376 assist to seat the cells 350 in the heat sink 364.

As current flows from the battery cells 350 to power the tool, heat is generated. Through both convection and conduction heat is transferred from the cells 350 to the heat sink 364. As the temperature of the heat sink 364 increases the heat sink 364 is cooled by the ambient air outside the battery pack 310. The size and shape of the heat sink 364 is selected in order to provide the greatest heat transfer from the heat sink 364 to the ambient air while also minimizing unwanted injury by a user.

When the heat sink 364 is seated in the bottom housing portion 316 and the cells 350 are seated on the heat sink 364 and the top housing portion 314 and the bottom housing portion 316 are fastened to each other, the battery cells 350 are fixed in the cell bays 372 and thermally coupled to the heat sink 364. As a result, the cavity 348 is sealed from the ambient air outside the battery pack 310 and airflow is prevented from moving from the cavity 348 around the heat sink 364, and therefore, most if not all heat transfer from the cells 350 will occur through the heat sink 364 to the ambient air outside the housing 312.

FIGS. 56-66 illustrate an alternate exemplary embodiment of the present invention. This embodiment includes a battery pack 410. The battery pack 410 has a housing 412. The housing 412 may be constructed of plastic or other suitable material for the application. The housing 412 includes a top housing portion 414 and a bottom housing portion 416. The top and bottom housing portions 414, 416 are joined at a horizontal parting line 418. The housing 412 also includes a first side 420, a second side 422, a front 424 and a back 426. The housing 412 is shown with a top and bottom portion. Other alternate configurations may be used to provide the housing for the various other components to be discussed below. For example, the housing could consist of two side housings that are joined at a vertical parting line.

The battery pack 410 includes a connection mechanism 428 for mechanically and electrically coupling the battery pack 410 to a power tool. As noted above, the inventive features of the present invention may be use in battery packs for other electronic devices which will require device specific connection mechanisms. The connection mechanism 428 includes rails 430 and grooves 432 for a sliding connection with the tool. The tool will include corresponding rails and grooves. The connection mechanism 428 also includes a spring loaded latch 434. The latch 434 will include a portion for receiving a user's finger to depress the latch 434 and a catch feature 435 that will be received in the base of the tool to maintain the battery pack 410 fixed to the tool. The battery pack also includes a terminal block 452 including a plurality of terminals 454 for transmitting current between the battery pack 410 and the tool. The current may be both for providing power to the tool and data between the battery pack and the tool.

While not illustrated in this exemplary embodiment, such an embodiment may include a state of charge indicator as described above.

The bottom housing portion 416 includes an exterior surface 442. The battery pack 410 also includes a heat sink 464 that is attached to the bottom housing portion 416. The heat sink 464 may be attached to the bottom housing portion 416 either from the outside of the housing 412 or from the inside of the housing 412. The bottom housing portion 416 includes an interior surface 456 and an opening 446. The heat sink 464 is positioned in the opening 446. The opening 446 and the heat sink 464 are configured such that a friction fit is formed between the opening 446 and the heat sink 464. The heat sink 464 has an exterior surface 466 and an interior surface 468. The heat sink 464 is configured such that when the heat sink 464 is attached to the bottom housing portion 416 and the bottom housing portion 416 is fastened to the top housing portion 414, the exterior surface 466 of the heat sink 464 is in a plane with a portion of the bottom surface 442. Such a configuration allows the battery pack 410 to easily rest on a surface when the battery pack 410, either alone or in conjunction with a tool, is placed bottom surface 442 down.

The battery pack 410 includes a plurality of fasteners 484 that pass through the bottom housing portion 416 and the top housing portion 414 and fastens the two housing portions to each other. Once the top housing portion 414 and the bottom housing portion 416 are fastened, the battery cells 450 are received in the cell bays 472 and thermally coupled to the heat sink 464.

The battery pack 410 includes a plurality of battery cells 450. This particular example illustrates five cells however, more or less cells may be present and the scope of the invention should not be limited to five cells. The cells 450 are typically Li Ion chemistry cells but may be other chemistries.

The bottom housing portion 416 includes an opening 446 that receives the heat sink 464. When the heat sink 464 is placed in the opening 446 and the top and bottom housing portions 414, 416 are fastened to each other, a seal is formed between the ambient air outside the battery pack 410 and a cavity 448 inside the housing 412. The bottom housing portion 416 includes a bottom housing interior surface 456 and first and second bottom housing interior side surfaces 458, 460.

The heat sink 464 may, for example, be made of aluminum, zinc, or magnesium. The heat sink 464 is preferably constructed of a material that has high specific heat and high heat transfer characteristics.

The interior surface 468 includes a plurality of concave receiving bays 472. Each bay 472 receives one of the plurality of cells 450. The cells 450 rest on and are in direct contact with the heat sink 464. The interior surface 468 may also includes an upper plurality of recesses 474 which could receive corresponding cross bars 476 of a battery harness 478. The battery harness 478 and the cross bars 476 assist to seat the cells 450 in the heat sink 464.

As current flows from the battery cells 450 to power the tool, heat is generated. Through both convection and conduction heat is transferred from the cells 450 to the heat sink 464. As the temperature of the heat sink 464 increases the heat sink 464 is cooled by the ambient air outside the battery pack 410. The size and shape of the heat sink 464 is selected in order to provide the greatest heat transfer from the heat sink 464 to the ambient air while also minimizing unwanted injury by a user.

When the heat sink 464 is seated in the bottom housing portion 416 and the cells 450 are seated on the heat sink 464 and the top housing portion 414 and the bottom housing portion 416 are fastened to each other, the battery cells 450 are fixed in the cell bays 472 and thermally coupled to the heat sink 464. As a result, the cavity 448 is sealed from the ambient air outside the battery pack 410 and airflow is prevented from moving from the cavity 448 around the heat sink 464, and therefore, most if not all heat transfer from the cells 450 will occur through the heat sink 464 to the ambient air outside the housing 412.

FIGS. 67-77 illustrate an alternate exemplary embodiment of the present invention. This embodiment includes a battery pack 510. The battery pack 510 has a housing 512. The housing 512 may be constructed of plastic or other suitable material for the application. The housing 512 includes a top housing portion 514 and a bottom housing portion 516. The top and bottom housing portions 514, 516 are joined at a horizontal parting line 518. The housing 512 also includes a first side 520, a second side 522, a front 524 and a back 526. The housing 512 is shown with a top and bottom portion. Other alternate configurations may be used to provide the housing for the various other components to be discussed below. For example, the housing could consist of two side housings that are joined at a vertical parting line.

The battery pack 510 includes a connection mechanism 528 for mechanically and electrically coupling the battery pack 510 to a power tool. As noted above, the inventive features of the present invention may be use in battery packs for other electronic devices which will require device specific connection mechanisms. The connection mechanism 528 includes rails 530 and grooves 532 for a sliding connection with the tool. The tool will include corresponding rails and grooves. The connection mechanism 528 also includes a spring loaded latch 534. The latch 534 will include a portion for receiving a user's finger to depress the latch 534 and a catch feature 535 that will be received in the base of the tool to maintain the battery pack 510 fixed to the tool. The battery pack also includes a terminal block 552 including a plurality of terminals 554 for transmitting current between the battery pack 510 and the tool. The current may be both for providing power to the tool and data between the battery pack and the tool.

While not illustrated in this exemplary embodiment, such an embodiment may include a state of charge indicator as described above.

The bottom housing portion 516 includes an exterior surface 542. The battery pack 510 also includes a heat sink 564 that is attached to the bottom housing portion 516. The heat sink 564 may be attached to the bottom housing portion 516 either from the outside of the housing 512 or from the inside of the housing 512. The bottom housing portion 516 includes an interior surface 556 and an opening 546. The heat sink 564 is positioned in the opening 546. The opening 546 and the heat sink 564 are configured such that a friction fit is formed between the opening 546 and the heat sink 564. The heat sink 564 has an exterior surface 566 and an interior surface 568. The heat sink 564 is configured such that when the heat sink 564 is attached to the bottom housing portion 516 and the bottom housing portion 516 is fastened to the top housing portion 514, the exterior surface 566 of the heat sink 564 is in a plane with a portion of the bottom surface 542. Such a configuration allows the battery pack 510 to easily rest on a surface when the battery pack 510, either alone or in conjunction with a tool, is placed bottom surface 542 down.

The battery pack 510 includes a plurality of fasteners 584 that pass through the bottom housing portion 516 and the top housing portion 514 and fastens the two housing portions to each other. Once the top housing portion 514 and the bottom housing portion 516 are fastened, the battery cells 550 are received in the cell bays 572 and thermally coupled to the heat sink 564.

The battery pack 510 includes a plurality of battery cells 550. This particular example illustrates five cells however, more or less cells may be present and the scope of the invention should not be limited to five cells. The cells 550 are typically Li Ion chemistry cells but may be other chemistries.

The bottom housing portion 516 includes an opening 546 that receives the heat sink 564. When the heat sink 564 is placed in the opening 546 and the top and bottom housing portions 514, 516 are fastened to each other, a seal is formed between the ambient air outside the battery pack 510 and a cavity 548 inside the housing 512. The bottom housing portion 516 includes a bottom housing interior surface 556 and first and second bottom housing interior side surfaces 558, 560.

The heat sink 564 may, for example, be made of aluminum, zinc, or magnesium. The heat sink 564 is preferably constructed of a material that has high specific heat and high heat transfer characteristics.

The interior surface 568 includes a plurality of concave receiving bays 572. Each bay 572 receives one of the plurality of cells 550. The cells 550 rest on and are in direct contact with the heat sink 564. The interior surface 568 may also includes an upper plurality of recesses 574 which could receive corresponding cross bars 576 of a battery harness 578. The battery harness 578 and the cross bars 576 assist to seat the cells 550 in the heat sink 564.

As current flows from the battery cells 550 to power the tool, heat is generated. Through both convection and conduction heat is transferred from the cells 550 to the heat sink 564. As the temperature of the heat sink 564 increases the heat sink 564 is cooled by the ambient air outside the battery pack 510. The size and shape of the heat sink 564 is selected in order to provide the greatest heat transfer from the heat sink 564 to the ambient air while also minimizing unwanted injury by a user.

When the heat sink 564 is seated in the bottom housing portion 516 and the cells 550 are seated on the heat sink 564 and the top housing portion 514 and the bottom housing portion 516 are fastened to each other, the battery cells 550 are fixed in the cell bays 572 and thermally coupled to the heat sink 564. As a result, the cavity 548 is sealed from the ambient air outside the battery pack 510 and airflow is prevented from moving from the cavity 548 around the heat sink 564, and therefore, most if not all heat transfer from the cells 550 will occur through the heat sink 564 to the ambient air outside the housing 512.

An alternative exemplary embodiment of one aspect of the present invention is illustrated in FIG. 78. The features illustrated in FIG. 78 may be incorporated into a battery pack of any of the foregoing embodiments. The battery pack housing includes a bottom housing portion 616. The battery pack includes a plurality of battery cells 650. The battery pack also includes a heat sink 664. The heat sink 664 includes a plurality of receiving bays 672. Each bay 672 receives one of the plurality of battery cells 650. When assembled, the battery cells 650 are positioned such that an air gap 690 is present between the battery cells 650 and the heat sink 664. Any of the foregoing embodiments of the battery pack may include an air gap between the battery cells and the heat sink.

An alternative exemplary embodiment of one aspect of the present invention is illustrated in FIG. 79. The features illustrated in FIG. 79 may be incorporated into a battery pack of any of the foregoing embodiments. The battery pack housing includes a bottom housing portion 716. The battery pack includes a plurality of battery cells 750. The battery pack also includes a heat sink 764. The heat sink 764 includes a plurality of receiving bays 772. Each bay 772 receives one of the plurality of battery cells 750. The battery pack also includes a thermally conductive coupling element 790 positioned in each of the bays 772. The thermally conductive coupling element 790 may be, for example, a thermal gap filler, a gap pad or a thermal adhesive. The thermally conductive coupling element 790 provides thermal conductivity between the battery cell 750 and the heat sink 764. Any of the foregoing embodiments of the battery pack may include a thermal coupling element between the battery cells and the heat sink.

An alternative exemplary embodiment of one aspect of the present invention is illustrated in FIG. 80. A heat sink 864 may include a cut out pattern 890 in an exterior surface 866 of the heat sink 864. The cut out pattern 890 includes a plurality of cut-outs or grooves 892 in the heat sink 864. The cut-outs 892 form a plurality of ribs 894 having a width W. In the illustrated embodiment, the cut-outs 892 have a rectangular cross section and have a uniform height H and length L. By changing the height H and the length L and width W, the temperature of the exterior surface 866 and the heat dissipation characteristics of the heat sink 864 can be varied. The area of the cut-outs 892 between the ribs 894 may be left empty or filled with an insulating material. In an alternate embodiment, the height H and length L of individual cut-outs 892 and the width W of individual ribs 894 may vary. The cut out pattern 890 may be oriented in the illustrated direction or in a direction perpendicular to the illustrated direction. Any of the foregoing embodiments of the battery pack may include a heat sink including a cut out pattern described with respect to this embodiment.

Another alternative exemplary embodiment of one aspect of the present invention is illustrated in FIG. 81. A heat sink 964 may include a cut out pattern 990 in an exterior surface 966 of the heat sink 964. The cut out pattern 990 includes a plurality of cut-outs or grooves 992 in the heat sink 964. The cut-outs 992 form a plurality of ribs 994 having a width W. In the illustrated embodiment, the cut-outs 992 have a triangular cross section and have a uniform height H and length L. By changing the height H and the length L and width W, the temperature of the exterior surface 966 and the heat dissipation characteristics of the heat sink 964 can be varied. The area of the cut-outs 992 between the ribs 994 may be left empty or filled with an insulating material. In an alternate embodiment, the height H and length L of individual cut-outs 992 and the width W of individual ribs may vary. The cut out pattern 990 may be oriented in the illustrated direction or in a direction perpendicular to the illustrated direction. Any of the foregoing embodiments of the battery pack may include a heat sink including a cut out pattern described with respect to this embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A battery pack comprising:
a housing defining a cavity for receiving at least one battery cell, the housing having a first side providing a connection to a tool and a second side opposed to the first side, the second side having an opening to the cavity, and
a heat sink positioned in the opening such that an interior surface of the heat sink is exposed to the cavity and an exterior surface of the heat sink is exposed to ambient air outside the housing.

2. A battery pack, as set forth in claim 1, further comprising at least one battery cell in the cavity, the battery thermally coupled to the heat sink.

3. A battery pack, as set forth in claim 2, further comprising a thermally conductive element coupling the at least one battery cell to the heat sink.

4. A battery pack, as set forth in claim 3, wherein the thermally conductive element is a thermal adhesive.

5. A battery pack, as set forth in claim 3, wherein the thermally conductive element is a gap pad.

6. A battery pack, as set forth in claim 3, wherein the thermally conductive element is a thermal gap filler.

7. A battery pack, as set forth in claim 1, further comprising a mesh portion adjacent to the exterior surface of the heat sink.

8. A battery pack, as set forth in claim 1, wherein the exterior surface of the heat sink includes a grooved pattern.

9. A battery pack, as set forth in claim 1, wherein an outer surface of the heat sink is in a plane of the outer surface of the second side of the housing.

10. A battery pack, as set forth in claim 1, wherein the housing includes an upper portion and a lower portion, the upper portion including the first side and the lower portion including the second side and further comprising a plurality of fasteners that mechanically couple the heat sink, the lower portion and the upper portion.

11. A battery pack comprising:
a housing defining a cavity for receiving at least one battery cell, the housing having a first side providing a connection to a tool and a second side, opposed to the first side, the second side having a mesh portion providing a plurality of openings between the cavity and ambient air outside the housing, and
a heat sink in the cavity positioned adjacent to the mesh portion.

12. A battery pack, as set forth in claim 11, further comprising at least one battery cell in the cavity, the battery thermally coupled to the heat sink.

13. A battery pack, as set forth in claim 12, further comprising a thermally conductive element coupling the at least one battery cell to the heat sink.

14. A battery pack, as set forth in claim 14, wherein the thermally conductive element is a thermal adhesive.

15. A battery pack, as set forth in claim 13, wherein the thermally conductive element is a gap pad.

16. A battery pack, as set forth in claim 13, wherein the thermally conductive element is a thermal gap filler.

17. A battery pack, as set forth in claim 11, wherein an outer surface of the heat sink abuts an inner surface of the mesh portion.

18. A battery pack, as set forth in claim 11, wherein the heat sink abuts the mesh portion to seal the cavity from the ambient air outside the housing.

19. A battery pack comprising:
a housing defining a cavity for receiving at least one battery cell, the housing having a first side having a mesh portion providing a plurality of openings between the cavity and ambient air outside the housing, and
a heat sink in the cavity positioned adjacent to the mesh portion.

20. A battery pack, as set forth in claim 19, wherein an outer surface of the heat sink abuts an inner surface of the mesh portion.

21. A battery pack, as set forth in claim 19, wherein the heat sink abuts the mesh portion to seal the cavity from the ambient air outside the housing.
